(19) United States
(12) Patent Application Publication
(10) Pub. No.: US 2015/0313400 A1
(43) Pub. Date: Nov. 5, 2015

(54) VACUUM LOW-TEMPERATURE COOKER

(71) Applicant: Zhihe Hu, Dongguan (CN)

(72) Inventor: Zhihe Hu, Dongguan (CN)

(73) Assignee: BIGLAND ELECTRIC APPLIANCE CO.,LTD., Dongguan City, Guangdong (CN)

(21) Appl. No.: 13/821,226

(22) PCT Filed: Jul. 10, 2012
(86) PCT No.: PCT/CN2012/078405

§ 371 Date: Mar. 30, 2015

(30) Foreign Application Priority Data
Nov. 9, 2011 (CN) 201110353691. X

(51) Int. Cl. A47J 27/10

(52) U.S. Cl. CPC A47J 27/10

(57) ABSTRACT

The invention discloses a vacuum low-temperature cooker comprising a housing, an inner pot comprising a basin and a lid, and a heating circulation system comprising a heater, a water pump and connecting pipes. The heater, the water pump and the basin are connected in series through the connecting pipes to construct a closed circulation loop. The basin is equipped with an inlet and an outlet associated with the connecting pipes. The invention makes the temperature inside the inner pot to be constant, such heating circulation loop also makes the water therein to absorb 95% energy emitted by the heater with energy saving. Meanwhile the heater is mounted outside the inner pot, such arrangement makes the inner pot having a maximum space to cook and clean.

### FIELD OF TECHNOLOGY

The present invention relates to a cooker, in particular a vacuum low-temperature cooker.

### BACKGROUND

Vacuum low-temperature cooking is a heating cooking method that food can be cooked in the water at a consistent relative lower temperature for a long time. It needs a long time, sometimes even more than 24 hours, to cook food stuffs. Unlike slow cooking, vacuum low-temperature cooking is a method that immerses a sealed plastic bag containing food in hot water at a temperature lower than boiling (e.g. 60° C. or 140T) for a long time. Furthermore, vacuum low-temperature cooking requires an accurate controlling of hot water temperature, since an offset of 1° C. should have impact on the quality of the food cooked.

For conventional vacuum low-temperature cooker, there are two types of heater. One is provided on the bottom of the inner pot of the cooker closely, while another one is provided inside the inner pot. The temperature inside the inner pot will be kept constant through electrically controlling the heater via a temperature sensor disposed outside the inner pot.

Its drawback occurred because the foresaid heating types caused in higher temperature in an internal position of the inner pot adjacent to the heater, and an inequal water temperature inside the inner pot, to impact on the quality of food cooked. Further there were no contact between the sensor and water, which also caused in an offset between temperature shown and real water temperature so as to further impact on the quality of food cooked.

### SUMMARY

It is an object of the invention to relieve the above drawbacks and to provide a vacuum low-temperature cooker, wherein a heater is disposed outside the inner pot of the cooker without any contact with the inner pot, the water temperature inside the inner pot is evenly unanimous such that the temperature of the food is evenly unanimous and can ensure the quality of food cooked.

To achieve the above object, the present invention employs the following technical solution:

A vacuum low-temperature cooker comprises a housing, an inner pot comprising a basin and a lid, and a heating circulation system comprising a heater, a water pump and connecting pipes. Said heater, said water pump and said basin are connected in series through said connecting pipes to construct a closed circulation loop. Said basin is equipped with an inlet and an outlet associated with said connecting pipes. Said heater is secured on said housing via a fixed bracket.

Further the inlet disposed at the bottom of the basin is equipped with a cored screw and a tee coupling. The first end of said tee coupling is connected to the basin, the second end of said tee coupling is connected to said water pump through said connecting pipe and the third end of said tee coupling is connected to a vent mechanism comprising a handle to make the vent to open or close.

Furthermore said tee coupling is equipped with a temperature sensor having contact with water directly.

Furthermore an outer filter component is disposed detachably inside said cored screw, an inner filter component is fixed irremovably between said cored screw and said tee coupling.

Furthermore said outer filter component comprises an outer filter outer-holder, an outer filter and an outer filter inner-holder.

Furthermore said outlet is disposed at the side wall of the basin by means of a cored screw and a bend.

Furthermore head of said cored screw has four orifices, two of which orienting front direction, other two of which orienting left direction and right direction respectively.

Furthermore said lid comprises an outer lid and an inner lid, said inner lid is equipped with a front buckle and a rear buckle which can be engaged with said outer lid respectively.

Furthermore a base plate is mounted on the bottom of the housing, said base plate has a recess in which the base is disposed. There are numbers of protuberances with a 20 degree angle each other around the surface of the recess in order to support the base, said housing can be rotated relative to said base. Furthermore a temperature sensor is disposed at a portion inside the bend adjacent to the end of said heater associated with said outlet.

The present invention has the following advantageous effects as compared with the prior art:

The present invention makes the temperature inside the inner pot to be constant, and such heating circulation loop also makes the water therein to absorb 95% energy emitted by the heater with energy saving. Meanwhile the heater is mounted outside the inner pot, and secured on the housing via a fixed bracket, so such arrangement makes the inner pot having a maximum space to cook and easy to clean.

The vent mechanism allows the water inside the inner pot to flow out, which makes the user to discharge the water easily and safely.

The temperature sensor is disposed at the inlet of water pump and contacts with the water, which enables the sensor to show the real water temperature in order to keep the water temperature constant by means of accurate control.

The connecting pipe between the inner pot and the pump is equipped with two filter apparatus, one apparatus is fixed in the connecting pipe, and the other one is a removable filter, such arrangement can prevent some stuff from entering into the circulation pipe and blocking the pipe, and enable the user to clean the pipe easily.

Head of the cored screw has four orifices orienting four different directions, thereby water sprays out from the four orifices to chum up the water inside the basin, such that the temperature of the water in the basin will be evenly identical.

The lid comprises an outer lid and an inner lid, such structure enables the temperature of outer surface of the lid to be low, and prevents the user from being scalded, and keeps the temperature inside well, and save energy.

The housing can be rotated at 360 degrees relative to the base, such arrangement enables the user to facilitate adjusting the direction of the cooker conveniently.

### BRIEF DESCRIPTION OF THE DRAWINGS

The invention will be best understood by reference to the following detailed description of illustrative embodiment in conjunction with the accompanying drawings, however, the drawings will not construct a limitation to the invention, wherein

FIG. 1 depicts an entire exploded view of a vacuum low-temperature cooker according to the present invention;

FIG. 2 depicts a top view of the vacuum low-temperature cooker according to the present invention;

FIG. 3 depicts a sectional view along with A-A line of FIG. 2;

FIG. 4 depicts a sectional view along with B-B line of FIG. 2;

FIG. 5 depicts a sectional view along with C-C line of FIG. 2;

FIG. 6 depicts the direction of waterflow from the water outlet;

FIG. 7A-7D depict a schematic detailed views of lid of the vacuum low-temperature cooker according to the present invention;

FIG. 8 depicts a schematic bottom view of the vacuum low-temperature cooker according to the present invention, wherein the housing of the cooker can be rotated relative to the base of the cooker;

### DETAILED DESCRIPTION OF THE INVENTION

A preferable embodiment of the present invention will be described here with reference to the accompanying drawings, however, it is appreciated that the embodiment here is used in a descriptive sense only and not for purposes of limitation.

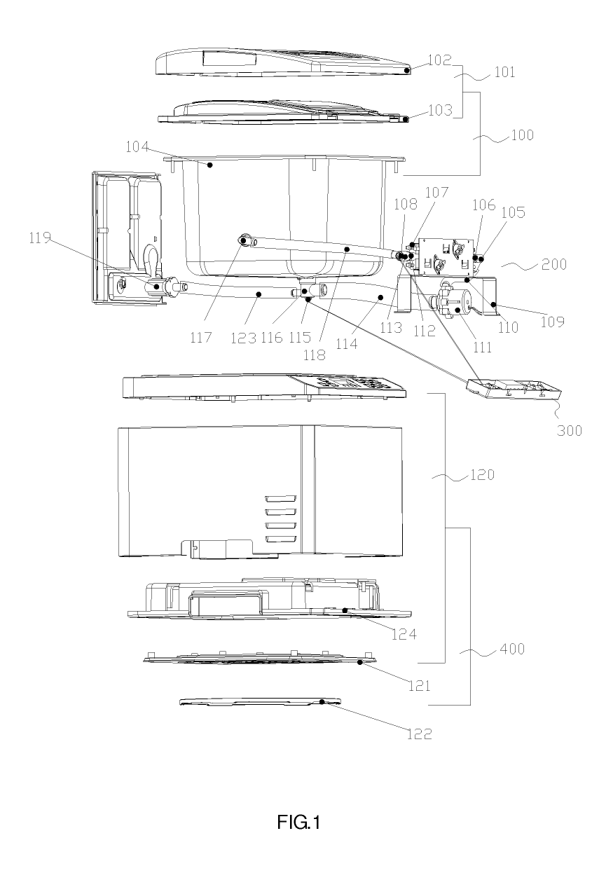

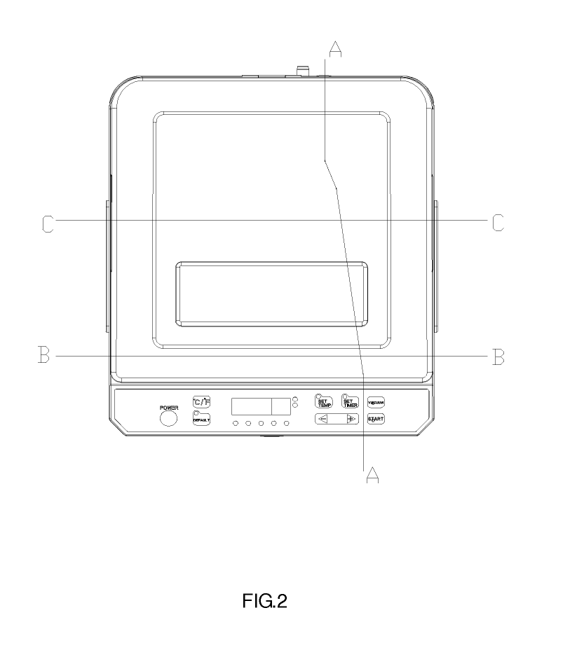

As illustrated in FIGS. 1 and 2, a vacuum low-temperature cooker of the present invention comprises an inner pot 100, a heating circulation system 200 and a housing 400, wherein the inner pot 100 and the heating circulation system 200 are disposed inside the housing 400, the inner pot 100 comprises a basin 104 for containing water when cooking, and a lid 101 for covering the basin 104, the heating circulation system 200 comprises a pump 111, a heater 107 and an electronic control system 300, the heater 107 works under the control of the system 300 in order to ensure the constant water temperature inside the inner pot 100.

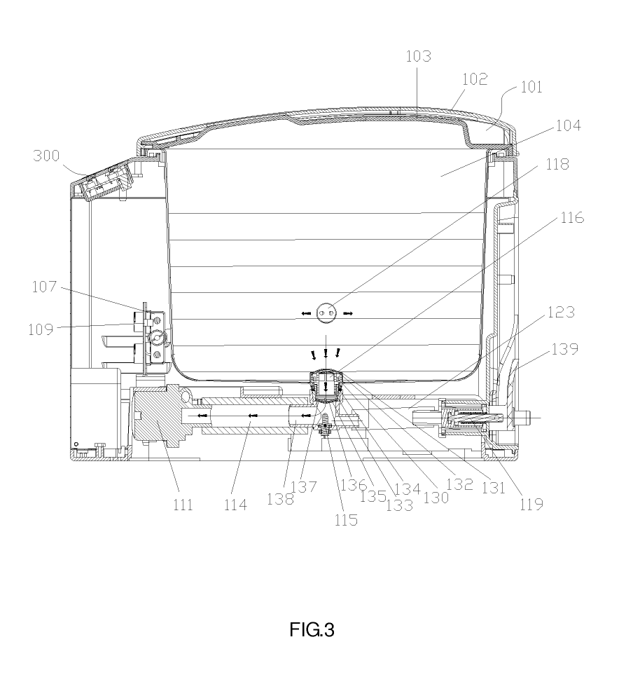

There are no physical touch between the heater 107 and the inner pot 100. FIG. 3-5 illustrate the direction of waterflow inside the basin 104 when cooking. Water inside the basin 104 flows from the inlet 116 and enters the water pump 111 through a connecting pipe 114, and then will be forced into the heater 107 after the water pump 111, through a connection pipe 110, a bend 105 and a connecting pipe 106, the water will be heated and go to the outlet 117 through a connecting pipe 112, a bend 113 and a connecting pipe 118, such that the water enters the basin 104 again from the outlet 117, and thereby a closed water circulation is formed. Preferably the inlet 116 was disposed at the bottom of the basin 104 by means of a cored screw 134 and a tee coupling 138. The first end of the tee coupling 138 is connected to the basin 104, the second end of the tee coupling 138 is connected to the water pump 111 through a connecting pipe 114 and the third end of the tee coupling 138 is connected to the vent mechanism 119 through the connecting pipe 123. A temperature sensor 115 is fixed at the tee coupling 138 to contact with the water inside the tee coupling 138 directly, in order to sample the water temperature. The water pump 111 is fixed in the box 124 beneath the basin 104, and is connected to one end of the heater 107 through the connecting pipe 110, the bend 105 and the connecting pipe 106. The other end of the heater 107 is connected to the basin 104 through the connecting pipe 112, the bend 113, the connecting pipe 118 and the outlet 117. The heater is fixed on the housing 400 by means of a fixed bracket 109. A protected temperature sensor 108 is fixed on the bend 113. The outlet 117 is disposed at the side wall of the basin 104 by means of a cored screw 151 and a bend 150, at the position 30 to 200 mm high from the basin bottom. It is 65 mm high in this embodiment.

The protected temperature sensor 108 is arranged at the water circulation, and the end of the heater 107 is connected to the connecting pipe 118. The heater 107 will be controlled by the electronic control system to stop working when high temperature of water flow through the heater 107 is detected by the protected temperature sensor 108, and the heater 107 can be resumed until back to the normal water temperature. However all power supply will be cut off if the high temperature is found twice during a working period, such arrangement can prevent the connecting pipe 118 from being blocked, avoiding the high water temperature to damage the cooker.

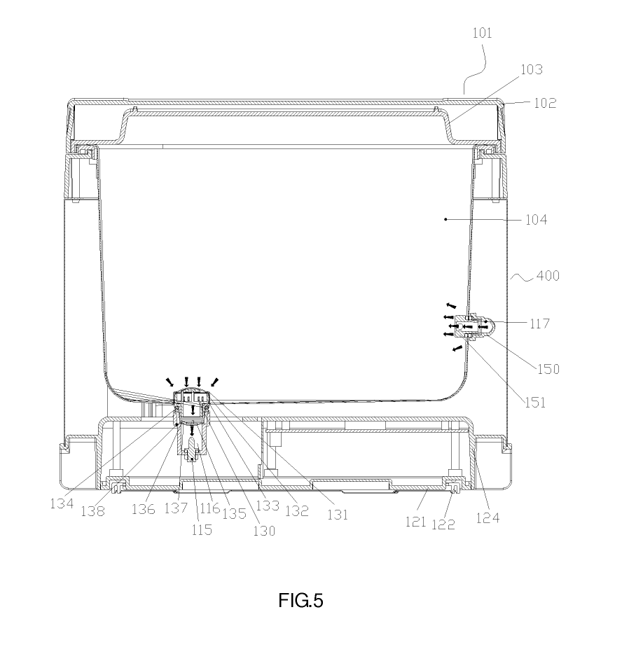

FIG. 5 is a sectional view of the basin 104 depicting the arrangement of the inlet 116 and outlet 117 thereon. The inlet 116 comprises an outer filter component 130, the cored screw 134, an inner filter component 135 and the tee coupling 138. The outlet 117 comprises the bend 150 and the cored screw 151. Preferably the inlet 116 is fixed on the basin 104 by means of the cored screw 134 and the tee coupling 138. The outer filter component 130 is disposed detachably on the cored screw 134, and can be separated into an outer filter outer-holder 131, an outer filter 132 and an outer filter inner-holder 133, such elements can be separated to clean and combined easily by the user after cleaning. The inner filter component 135 is fixed irremovable between the cored screw 134 and the tee coupling 138. Such two-layers filter configuration enables a perfect filter effect, and a separable outer filter also enables the user to clean the filter if necessary in order to prevent the water pipe from being blocked.

The temperature sensor 115 is fixed inside the tee coupling 138, and the sensing portion is oriented in the bottom of the basin 104, i.e. the sensor 115 is disposed at the inlet 116. Such arrangement makes the sensor 115 to contact with water directly, enabling the sensing temperature being identical to real water temperature and the temperature control being more accurate.

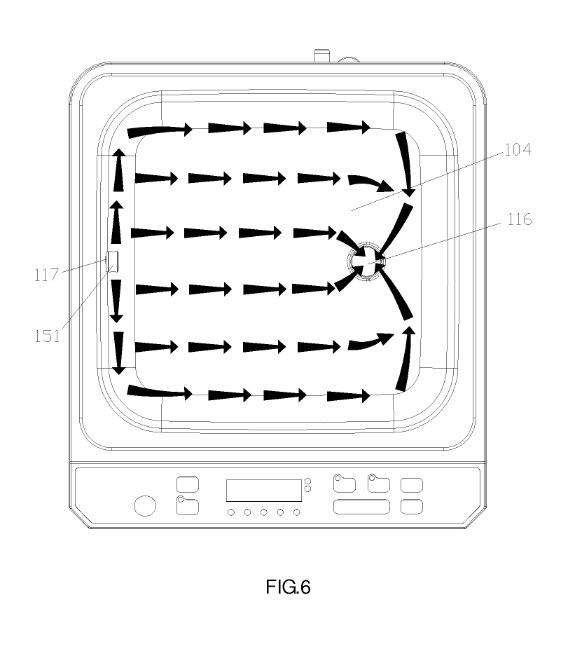

The outlet 117 is disposed at the side wall of the basin 104 by means of a cored screw 151 and a bend 150 as shown in FIG. 6, wherein the head of the cored screw 151 has four orifices, two of which in front, other two of which in left and right respectively. Heating water from the heater 107, driven by the pump 111, flows into the cored screw 151, and sprays out from the four orifices to churn up the water inside the basin, such that the water temperature around the basin will be substantially identical so as to ensure the quality of food immersed in the basin 104.

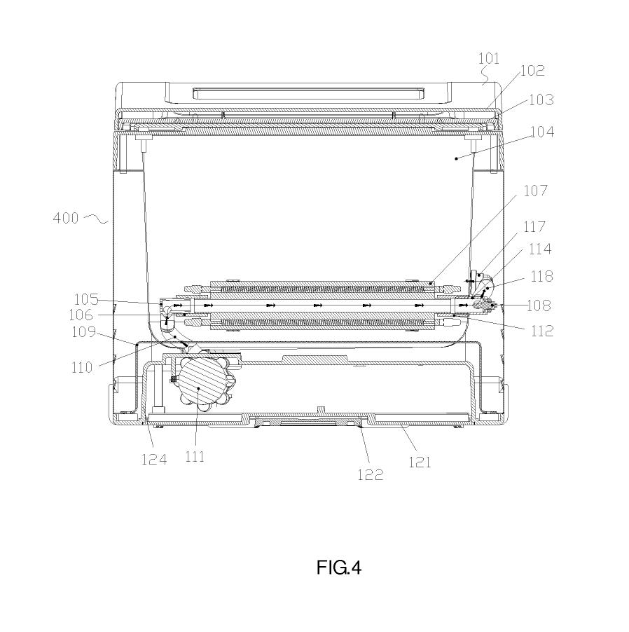

FIG. 4 is a sectional view depicting the way to fix and connect the heater 107. Preferably the heater 107 is secured at the fixed bracket 109, two ends of which are fixed on the housing 400, such that the heater 107 has no direct contact with the basin 104. One end of the heater 107 is connected to the water pump 111 through the connecting pipe 106, the bend 105 and the connecting pipe 110, the other end of the heater 107 is connected to the basin 104 through the connecting pipe 112, the bend 113, the connecting pipe 118 and the outlet 117. Preferably the protected temperature sensor 108 is fixed inside the bend 113, and the sensing portion is oriented in the end of the heater. Such arrangement makes the sensing temperature to be the water temperature after the heater 107, such temperature should be the highest temperature within the whole heating circulation system 200.

FIG. 3 depicts a sectional view of the vent mechanism 119. Preferably water within the basin 104 will outflow from the vent mechanism 119 via the inlet 116 and the connecting pipe 123 while a handle 139 was pulled down rotatably at approximate 90 degree to open the vent mechanism 119.

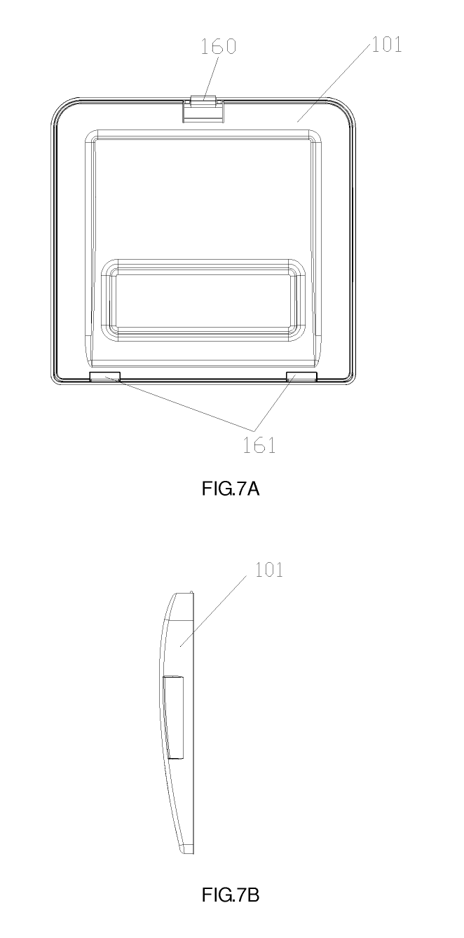

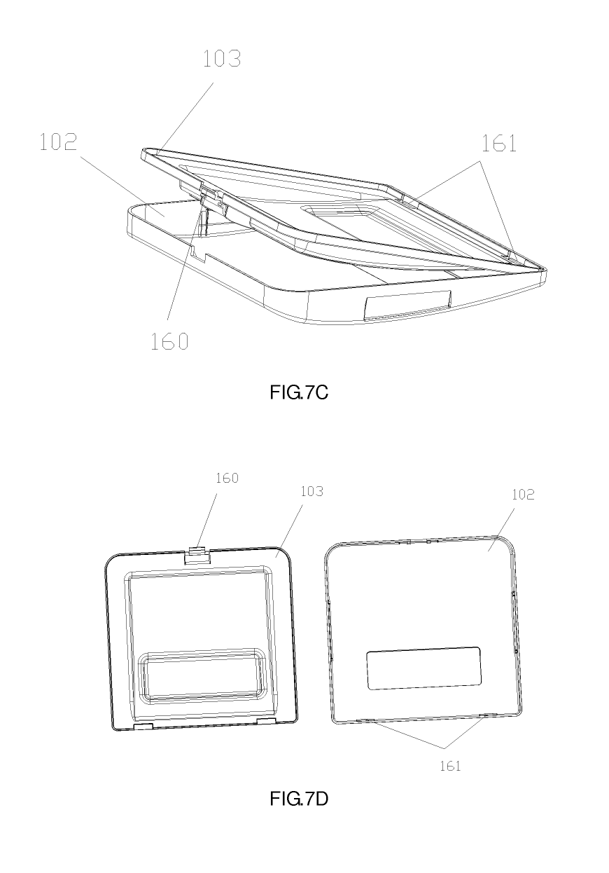

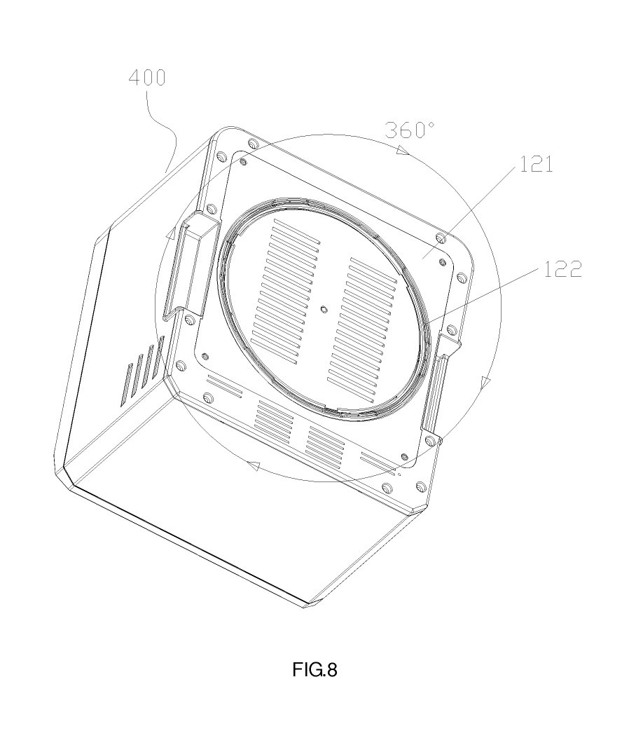

The lid 101 comprises an outer lid 102 and an inner lid 103 as shown in FIG. 7A-7D, the outer lid 102 and the inner lid 103 can be separated. Preferably the inner lid 103 can be raised when pushing in a rear buckle 160, and the inner lid 103 can be separated from the outer lid 102 while pulling out the inner lid 103 obliquely. However the inner lid 103 and the outer lid 102 can be combined together while inserting the inner lid 103 into a front buckle 161 obliquely and then pushing the inner lid 103 towards the outer lid 102.

FIG. 8 depicts that the housing 400 can be rotated at 360 degree relative to the base 122. Preferably a base plate has a circular recess in which the base 122 is disposed. There are number of protuberances around the surface of the circular recess in order to support the base 122 and reduce their friction thereof. The angle between every two adjacent protuberances is 20 degrees. When rotation occurs, the base 122 is secured on the table, and the housing 400 can be rotated relative to the base 122.

It is appreciated that the above is a preferred embodiment of the present invention only and not for purposes of limitation. Although the detailed descriptions have been disclosed with reference to typical embodiment of the invention, it is possible for the people skilled to make alterations or equatable substitutions according to the foresaid technique solutions or a part thereof. Any alterations, equatable substitutions or improvements within the spirit of the present invention should be incorporated into ambit of claims of the present invention.

What is claimed is:

1. A vacuum low-temperature cooker comprising a housing, an inner pot comprising a basin and a lid, and a heating circulation system, wherein said heating circulation system comprises a heater, a water pump and connecting pipes, said heater, said water pump and said basin are connected in series through said connecting pipes to construct a closed circulation loop, said basin is equipped with an inlet and an outlet associated with said connecting pipes.

2. The cooker according to claim 1, wherein said inlet disposed at the bottom of the basin is equipped with a cored screw and a tee coupling, with the first end of said tee coupling connected to the basin, the second end of said tee coupling connected to said water pump through said connecting pipe and the third end of said tee coupling connected to a vent mechanism comprising a handle to make the vent to open or close.

3. The cooker according to claim 2, wherein said tee coupling is equipped with a temperature sensor having contact with water directly.

4. The cooker according to claim 2, wherein an outer filter component is disposed detachably inside said cored screw, an inner filter component is fixed irremovably between said cored screw and said tee coupling.

5. The cooker according to claim 4, wherein said outer filter component comprises an outer filter outer-holder, an outer filter and an outer filter inner-holder.

6. The cooker according to claim 1, wherein said outlet is disposed at the side wall of the basin by means of a cored screw and a bend.

7. The cooker according to claim 6, wherein head of said cored screw has four water orifices, two of said orifices orienting front direction, other two of said orifices orienting left direction and right direction respectively.

8. The cooker according to claim 1, wherein said lid comprises an outer lid and an inner lid, said inner lid is equipped with a front buckle and a rear buckle which can be engaged with said outer lid respectively.

9. The cooker according to claim 1, wherein a base plate is mounted on the bottom of the housing, said base plate has a recess in which the base is disposed, there are numbers of protuberances around the surface of the recess in order to support the base, said housing can be rotated relative to said base.

10. The cooker according to claim 1, wherein a protected temperature sensor is disposed at a portion inside the bend adjacent to the end of said heater associated with said outlet.
